(19) United States
(12) Patent Application Publication
(10) Pub. No.: US 2025/0093514 A1
(43) Pub. Date: Mar. 20, 2025

(54) TECHNIQUES FOR ROBUST MACHINE VISION SYSTEMS

(71) Applicant: Cognex Corporation, Natick, MA (US)

(72) Inventors: Thomas Ruhnau, Herbolzheim (DE); Eric Moore, Boulder, CO (US)

(73) Assignee: Cognex Corporation, Natick, MA (US)

(21) Appl. No.: 18/830,442

(22) Filed: Sep. 10, 2024

Related U.S. Application Data
(60) Provisional application No. 63/581,945, filed on Sep. 11, 2023.

(51) Int. Cl. G01S 17/894; G01B 9/02; G01B 9/02015; G01S 7/481

(52) U.S. Cl. CPC G01S 17/894; G01B 9/02027; G01B 9/0203; G01B 9/02044; G01S 7/4817

(57) ABSTRACT

Compact and robust machine vision systems are provided herein. A machine vision system includes an optoelectronic system configured to emit measurement beams towards objects and a motion module configured to move the objects and/or components of the optoelectronic system. The machine vision system uses the relative motions to reduce degrees of freedom required to sample the objects to produce 3D images. The optoelectronic system includes a light source configured to emit a beam and sweep its frequency. The optoelectronic system includes primary interferometers configured to measure distances to points of an object and auxiliary interferometers configured with reference delays. The optoelectronic system includes electronic circuitry configured to interpret outputs of the interferometers into distance measurements by simpler computations in the time domain. The electronic circuitry is configured to measure frequency integrals of the interferometers and determine the distance measurements by comparing the measured frequency integrals.

### RELATED APPLICATION

This application claims priority under 35 U.S.C. § 119(e) to U.S. Provisional Application Ser. No. 63/581,945, titled “TECHNIQUES FOR ROBUST MACHINE VISION SYSTEMS,” filed on Sep. 11, 2023, which is herein incorporated by reference in its entirety.

### FIELD

The techniques described herein relate generally to imaging systems, including machine vision systems that are configured to acquire and analyze three-dimensional (3D) images of objects.

### BACKGROUND

Machine vision systems are generally configured to capture images and to analyze the images. For example, machine vision systems can be configured to capture images of objects and to analyze the images to identify the objects. As another example, machine vision systems can be configured to capture images of symbols and to analyze the images to decode the symbols. Accordingly, machine vision systems generally include one or more devices for image acquisition and image processing. In conventional applications, these devices can be used to acquire images, or to analyze acquired images, such as for the purpose of decoding imaged symbols (e.g., barcodes and/or text). In some contexts, machine vision and other imaging systems can be used to acquire images of objects that may be larger than a field of view (FOV) for a corresponding imaging device and/or that may be moving relative to an imaging device.

### SUMMARY

Aspects of the present disclosure relate to compact and robust machine vision system.

Some embodiments relate to a system configured to generate a 3D image of at least a portion of an object. The system can comprise a light source configured to emit a beam and modulate a wavelength of the beam; a coupler configured to split the beam into a first beam and a second beam; a first interferometer comprising a first reference arm and a first measurement arm, the first interferometer configured to: split the first beam into a first reference beam travelling along the first reference arm and a first measurement beam travelling along the first measurement arm, and provide a first output based, at least in part, on the first reference beam and a first reflected beam of the first measurement beam by the object; a second interferometer configured to provide a second output based, at least in part, on the second beam; a beam deflection device configured to direct the first measurement beam towards the object along a plurality of directions; and a motion module configured to provide a plurality of relative positions and/or orientations between the object and the beam deflection device, wherein: the 3D image is generated, by a processor, based, at least in part, on the first output of the first interferometer, the second output of the second interferometer, the plurality of directions, and the plurality of relative positions and/or orientations.

Some embodiments relate to a system configured to generate a 3D image of at least a portion of an object. The system can comprise a light source configured to emit a beam and modulate a wavelength of the beam; a coupler configured to split the beam into a plurality of first beams and a second beam; a plurality of first interferometers, each of the plurality of first interferometers comprising a first reference arm and a first measurement arm, the first interferometer configured to: split a respective one of the plurality of first beams into a first reference beam travelling along the first reference arm and a first measurement beam travelling along the first measurement arm, and provide a first output based, at least in part, on the first reference beam and a first reflected beam of the first measurement beam by the object; a second interferometer configured to provide a second output based, at least in part, on the second beam; a beam deflection device configured to direct the first measurement beams towards the object along a plurality of directions; and a motion module configured to provide a plurality of relative positions and/or orientations between the object and the beam deflection device, wherein: the 3D image is generated, by a processor, based, at least in part, on the first outputs of the plurality of first interferometers, the second output of the second interferometer, the plurality of directions, and the plurality of relative positions and/or orientations.

Optionally, the plurality of directions are along a same plane.

Optionally, the light source is configured by a controller to modulate the wavelength of the beam by a nonlinear frequency sweep.

Optionally, the light source is configured to modulate the wavelength of the beam by a sinusoidal frequency sweep.

Optionally, the second interferometer is configured with a reference delay; and the second output of the second interferometer corresponds to the reference delay.

Optionally, the system can comprise a first frequency integrator configured to determine a first count of oscillations in the first output of the first interferometer; and a second frequency integrator configured to determine a second count of oscillations in the second output of the second interferometer, wherein the 3D image is generated based, at least in part, on the first count of oscillations and the second count of oscillations.

Optionally, the system can comprise a third interferometer configured to provide a third output based, at least in part, on the second beam, wherein the 3D image is generated based, at least in part, on the third output of the third interferometer.

Optionally, the third interferometer is configured with a second reference delay; and the third output of the third interferometer corresponds to the second reference delay.

Optionally, the motion module is configured to support the object.

Optionally, the motion module is configured to move the object in 1D direction or 2D directions.

Optionally, the motion module is configured to support the beam deflection device.

Optionally, the motion module is configured to move the beam deflection device in 3D directions.

Some embodiments relate to A method for measuring distances to an object, the method comprising: modulating a wavelength of a beam that is split into a first beam emitted to a point of the object through a first interferometer, a second beam passing through a second interferometer, and a third beam passing through a third interferometer; converting outputs of the first interferometer, the second interferometer, and the third interferometer to a first electrical signal, a second electrical signal, and a third electrical signal, respectively; measuring a first frequency integral, a second frequency integral, and a third frequency integral based, at least in part, on the first electrical signal, the second electrical signal, and the third electrical signal, respectively; and determining the distance to the point of the object based, at least in part, on the first frequency integral, the second frequency integral, and the third frequency integral.

Optionally, the determined distance is a distance between the first interferometer and the point of the object.

Optionally, measuring the first frequency integral, the second frequency integral, and the third frequency integral comprises counting oscillations in the first electrical signal, the second electrical signal, and the third electrical signal, respectively.

Optionally, the wavelength of the beam is modulated by a sinusoidal frequency sweep.

Optionally, the point of the object is a first point of the object; and the method can comprise deflecting the beam along a plurality of directions such that the first beam is emitted to a plurality of points of the object including the first point of the object through the first interferometer; and determining the distances to the plurality of points of the object based, at least in part, on the first frequency integral, the second frequency integral, and the third frequency integral.

Optionally, the method can further comprise determining dimensions of the object based, at least in part, on the determined distances to the plurality of points of the object.

Optionally, the method can comprise splitting the first beam into a plurality of first beams; and emitting the plurality of first beams to a plurality of points of the object through a plurality of first interferometers, wherein the plurality of points include the point of the object, and the plurality of first interferometers comprise the first interferometer.

Optionally, the method can comprise the converting outputs of the plurality of first interferometers to a plurality of first electrical signals; measuring a plurality of first frequency integrals based, at least in part, on the plurality of first electrical signals; and determining distances to the plurality of points of the object based, at least in part, on the plurality of first frequency integrals, the second frequency integral, and the third frequency integral.

Optionally, the method can comprise determining dimensions of the object based, at least in part, on the determined distances to the plurality of points of the object.

Some embodiments relate to an optoelectronic system. The optoelectronic system can comprise a first receiver configured to receive a first output of a first interferometer; a first frequency integrator configured to provide a first frequency integral based, at least in part, on the first output of the first interferometer; a second receiver configured to receive a second output of a second interferometer; a second frequency integrator configured to provide a second frequency integral based, at least in part, on the second output of the second interferometer; a third receiver configured to receive a third output of a third interferometer; a third frequency integrator configured to provide a third frequency integral based, at least in part, on the third output of the third interferometer; and a comparator configured to compare the first frequency integral to the second frequency integral and the third frequency integral, wherein the comparison result indicates a delay of the first interferometer.

Optionally, the optoelectronic system can comprise a current amplifier configured to amplify the first output of the first interferometer.

Optionally, the optoelectronic system can comprise a filter configured to filter an amplified first output of the first interferometer.

Optionally, the first frequency integrator is configured to count oscillations in a filtered, amplified first output of the first interferometer.

Optionally, the optoelectronic system can further comprise a processor configured to execute computer-executable instructions, the computer-executable instructions comprising a 3D imaging component, the 3D imaging component configured to determine dimensions of an object measured by the first interferometer based, at least in part on, the delay of the first interferometer.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a schematic diagram illustrating an exemplary system configured to capture multiple images of sides of an object, according to some embodiments.

FIG. 1B is another schematic diagram of the system of FIG. 1A with the addition of a motion measurement device, according to some embodiments.

FIG. 2 is a schematic diagram illustrating another exemplary system configured to capture multiple images of sides of an object, according to some embodiments.

FIG. 3 is a schematic diagram illustrating a third exemplary system configured to capture multiple images of sides of an object, according to some embodiments.

FIG. 4A is a schematic diagram illustrating an exemplary system configured to capture three-dimensional (3D) images of objects that may be used in and/or with any of the systems of FIGS. 1A-3, according to some embodiments.

FIG. 4B is a schematic diagram illustrating another exemplary system configured to capture 3D images of objects that may be used in and/or with any of the systems of FIGS. 1A-3, according to some embodiments.

FIG. 4C is a schematic diagram illustrating a third exemplary system configured to capture 3D images of objects that may be used in and/or with any of the systems of FIGS. 1A-3, according to some embodiments.

FIG. 5A is a schematic diagram illustrating an exemplary optoelectronic system that may be used in and/or with any of the systems of FIG. 4A-4C, according to some embodiments.

FIG. 5B is a schematic diagram illustrating another exemplary optoelectronic system that may be used in and/or with any of the systems of FIG. 4A-4C, according to some embodiments.

FIG. 6A is a graph showing an ideal linear frequency sweep for frequency modulated continuous wave (FMCW) light detection and ranging (LiDAR).

FIG. 6B is a graph showing a non-ideal linear frequency sweep for FMCW LiDAR.

FIG. 7A is a graphical representation of a frequency integral A₀ of a primary interferometer that may be used in any of the optoelectronic systems of FIGS. 5A-5B, with respect to a delay to of the primary interferometer and the frequency sweep ΔF.

FIG. 7B is a graphical representation of frequency integrals A₁ and A₂ of first and second auxiliary interferometers that may be used in any of the optoelectronic systems of FIGS. 5A-5B, with respect to reference delays t₁ and t₂ of the auxiliary interferometers and the frequency sweep ΔF.

FIG. 7C is a graphical representation of the frequency integral A₀ of the primary interferometer of FIG. 7A, with respect to the delay to of the primary interferometer, determined based on the frequency integrals A₁ and A₂ and the reference delays t₁ and t₂ of the first and second auxiliary interferometers of FIG. 7B.

FIG. 8A is a schematic diagram illustrating an electrical signal converted by a photodetector from a beat frequency.

FIG. 8B is a schematic diagram illustrating a filtered electrical signal of the electrical signal of FIG. 8A and a frequency integral of the filtered electrical signal.

FIG. 9 is a schematic diagram illustrating an exemplary signal processing unit that may be used in and/or with any of the optoelectronic systems of FIGS. 5A-5B, according to some embodiments.

FIG. 10 is a schematic diagram showing a frequency sweep that may be used in any of the optoelectronic systems of FIGS. 5A-5B.

### DETAILED DESCRIPTION

The techniques described herein provide machine vision systems that can generate three-dimensional (3D) images of objects with simpler components and higher accuracy when compared to conventional machine vision systems. Such machine vision systems can be used to perform various machine vision tasks. For example, such machine vision systems can be used to measure the dimensions of parcels in the logistics industry, to inspect manufactured goods in the automation of factories, and/or to perform other processes that leverage machine vision. Optoelectronic systems (e.g., light detection and ranging (LiDAR) systems) may provide various advantages over camera-based 3D measurement systems (e.g., stereo and triangulation-based technologies), including by providing monostatic measurements, wider working ranges, higher dynamic ranges, and insensitivity to ambient light or other distortions. However, LiDAR systems, such as frequency modulated continuous wave (FMCW) LiDAR systems, have not been used for various machine vision applications. For example, FMCW LiDAR systems traditionally have not been used in applications such as logistics, factory automation, etc. due to various challenges, such as requiring a precisely controlled tunable light source and/or requiring high speed data acquisition with a powerful data processing unit for various computations (e.g., such as interpolation, resampling, and/or calculating Fast Fourier Transform (FFT)).

Machine vision systems described herein can enable the use of FMCW LiDAR systems for machine vision applications. The techniques can, for example, enable the use FMCW LiDAR systems to provide 3D images in applications with various limitations that may otherwise prevent the use of LiDAR systems, such as where the capability to control a tunable light source and/or computation resources are limited. For example, by detecting and using a motion of the target object, machine vision systems described herein can reduce the degrees of freedom required to sample a target object to produce a 3D image. As another example, machine vision systems described herein can additionally or alternatively reduce the requirements for the accuracy of the sweep characteristics of the light source, the complexity of the data acquisition and processing, and/or the like without compromising the accuracy and/or resolution of the measurement results.

Machine vision systems described herein may be configured to generate 3D images of objects, scenes, and/or physical environments. A 3D image can include 3D data in any suitable representation including, for example, a point cloud, a range image, and a depth map. One or more 3D images can be used to measure shapes and/or sizes of objects with high resolution. For example, such a system can be used to measure objects on a conveyor, e.g., packages in a logistics center or workpieces in automated factories. As further examples, such a system can be used to measure 3D shapes of objects in factory automation applications, outdoor applications, and/or applications involving vision-guided robots.

Machine vision systems described herein can include an optoelectronic system configured to emit measurement beams towards target objects and a motion module configured to change the relative position and/or orientation between the target objects and one or more components of the optoelectronic system. The motion module can be configured to move the target object. For example, the motion module can be a conveyor (e.g., a belt, roller, or chain conveyor) configured to move objects in a direction of motion, a motion stage configured to move objects in one or more directions on a plane, or a robotic arm configured to move objects in one or more directions. Alternatively or additionally, the motion module can be configured to move the one or more components of the optoelectronic system. For example, the motion module can be a robotic arm configured to move at least a portion of the optoelectronic system in 3D space.

The optoelectronic system can include a light source configured to emit a beam and modulate a wavelength of the beam. The light source can be configured by a controller (e.g., a light source control 618) to sweep its frequency, for example, in a sawtooth pattern or in a sinusoidal curve. Examples of the light source include, but are not limited to, a tunable vertical-cavity surface-emitting laser (VCSEL), and a distributed feedback (DFB) laser.

The beam emitted by the light source can be split into multiple beams, which can pass through respective interferometers. The beam can be a free-space beam, or light confined within, for example, optical fiber or integrated optical waveguides. The optoelectronic system can include one or more primary interferometers, and one or more auxiliary interferometers. Each primary interferometer can have a reference arm and a measurement arm configured towards a target object. Each auxiliary interferometer can have a respective reference delay, which can be predetermined based on, for example, ranges of target objects.

The optoelectronic system can include optical components configured to form a reference beam travelling along the reference arm of a primary interferometer and a measurement beam travelling along the measurement arm of the primary interferometer towards a target object. Alternatively or additionally, the optical components can be configured to form beams for multiple primary interferometers, for example, in a fan-shape.

The optoelectronic system can include a one-dimensional (1D) scanner configured to direct the measurement beam of a primary interferometry towards the target object along 1D direction. Alternatively or additionally, the optoelectronic system can include a two-dimensional (2D) scanner configured to direct the measurement beam of a primary interferometry towards the target object along 2D directions. Examples of scanners can include galvanometer mirrors, voice coils, MEMS mirrors, optical phased arrays, optical waveguide switch banks, and/or the like. A scanner can be referred to as a “beam deflection device.”

Beneficially, the optoelectronic system can include electronic circuitry configured to interpret outputs of the interferometers into distance measurements by relatively simpler computations conducted in the time domain instead of the frequency domain. The electronic circuitry can be configured to measure frequency integrals of the interferometers by, for example, counting oscillations in the outputs of respective interferometers. The distance measurements can be determined by comparing the measured frequency integrals.

Each distance measurement can be associated with a point in time. For each point in time, a 3D point in space may be determined by, for example, combining the associated distance measurement with an associated deflection direction of the beam by the scanner. The 3D point can correspond to a point on the target object in a coordinate system that may be determined based on the respective application. The relative positions (which can include varying orientations) between the target object and the scanner can be taken into account by resolving the spatial information at respective points in time. Multiple 3D points may form a 3D image. The 3D image may include a point cloud, a depth map, a range image, or other 3D data representation.

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

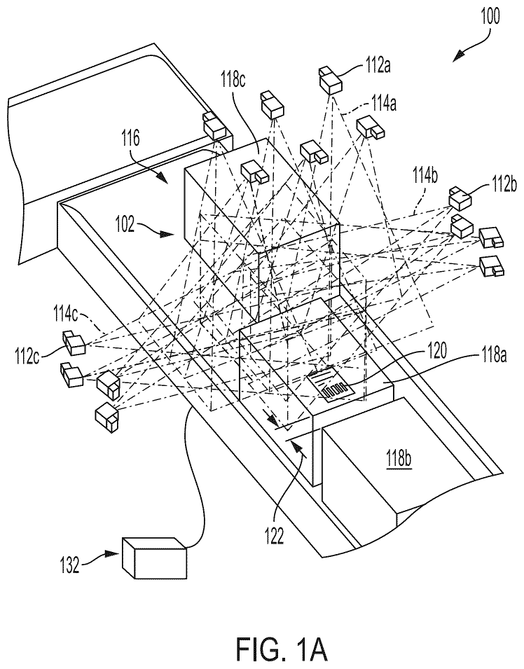

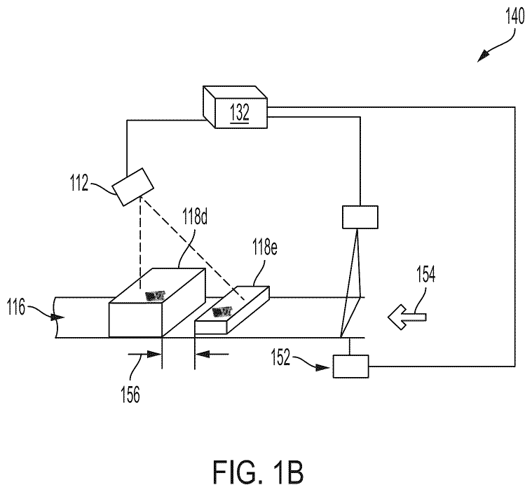

FIG. 1A shows an example of a system 100 for capturing multiple images of each side of an object in accordance with an embodiment of the technology. In some embodiments, system 100 can be configured to evaluate symbols (e.g., barcodes, two-dimensional (2D) codes, fiducials, hazmat, machine readable code, etc.) on objects (e.g., objects 118a, 118b) moving through a tunnel 102, such as a symbol 120 on object 118a, including assigning symbols to objects (e.g., objects 118a, 118b). In some embodiments, symbol 120 is a flat 2D barcode on a top surface of object 118a, and objects 118a and 118b are roughly cuboid boxes. Additionally or alternatively, in some embodiments, any suitable geometries are possible for an object to be imaged, and any variety of symbols and symbol locations can be imaged and evaluated, including non-direct part mark (DPM) symbols and DPM symbols located on a top or any other side of an object.

In FIG. 1A, objects 118a and 118b are disposed on a conveyor 116 that is configured to move objects 118a and 118b in a horizontal direction through tunnel 102 at a relatively predictable and continuous rate, or at a variable rate measured by a device, such as an encoder or other motion measurement device. Additionally or alternatively, objects can be moved through tunnel 102 in other ways (e.g., with non-linear movement). In some embodiments, conveyor 116 can include a conveyor belt. In some embodiments, conveyor 116 can consist of other types of transport systems (also referred to as, e.g., motion modules).

In some embodiments, system 100 can include imaging devices 112 and an image processing device 132. For example, system 100 can include multiple imaging devices in a tunnel arrangement (e.g., implementing a portion of tunnel 102), representatively shown via imaging devices 112a, 112b, and 112c, each with a field-of-view (“FOV”), representatively shown via FOV 114a, 114b, 114c, that includes part of the conveyor 116. In some embodiments, each imaging device 112 can be positioned at an angle relative to the conveyor top or side (e.g., at an angle relative to a normal direction of symbols on the sides of the objects 118a and 118b or relative to the direction of travel), resulting in an angled FOV. Similarly, some of the FOVs can overlap with other FOVs (e.g., FOV 114a and FOV 114b). In such embodiments, system 100 can be configured to capture one or more images of multiple sides of objects 118a and/or 118b as the objects are moved by conveyor 116. In some embodiments, the captured images can be used to identify symbols on each object (e.g., a symbol 120) and/or assign symbols to each object, which can be subsequently decoded (as appropriate). In some embodiments, an array of imaging devices 112 may be referred to as an imaging device, and imaging devices 112 in the array may be referred to as an imager.

In some embodiments, imaging devices 112 can be implemented using any suitable type of imaging device(s). For example, imaging devices 112 can be implemented using 2D imaging devices (e.g., 2D cameras), such as area scan cameras and/or line scan cameras. In some embodiments, imaging device 112 can be an integrated system that includes a lens assembly and an imager, such as a CCD or CMOS sensor. In some embodiments, imaging devices 112 may each include one or more image sensors, at least one lens arrangement, and at least one control device (e.g., a processor device) configured to execute computational operations relative to the image sensor. Each of the imaging devices 112a, 112b, or 112c can selectively acquire image data from different fields of view (FOVs). In some embodiments, system 100 can be utilized to acquire multiple images of each side of an object where one or more images may include more than one object. Object 118 may be associated with one or more symbols, such as a barcode, a QR code, etc. In some embodiments, system 100 can be configured to facilitate imaging of the bottom side of an object supported by conveyor 116 (e.g., the side of object 118a resting on conveyor 116). For example, conveyor 116 may be implemented with a gap (not shown).

In some embodiments, system 100 can include devices (e.g., an encoder or other motion measurement device, not shown) to track the physical movement of objects (e.g., objects 118a, 118b) moving through the tunnel 102 on the conveyor 116. FIG. 1B shows an example of a system for capturing multiple images of each side of an object in accordance with an embodiment of the technology. FIG. 1B shows a simplified diagram of a system 140 to illustrate an example arrangement of a motion measurement device (e.g., an encoder) with respect to a tunnel. As mentioned above, the system 140 may include a motion measurement device 152. In the illustrated example, a conveyor 116 is configured to move objects 118d, 118e along the direction indicated by arrow 154 past a motion measurement device 152 before the objects 118d, 118e are imaged by one or more imaging devices 112. In the illustrated embodiment, a gap 156 is provided between objects 118d and 118e and an image processing device 132 may be in communication with imaging devices 112 and motion measurement device 152.

In some embodiments, a motion measurement device 152 (e.g., an encoder) may be linked to the conveyor 116 and imaging devices 112 to provide electronic signals to the imaging devices 112 and/or image processing device 132 that indicate the amount of travel of the conveyor 116, and the objects 118d, 118e supported thereon, over a known amount of time. This may be useful, for example, in order to coordinate capture of images of particular objects (e.g., objects 118d, 118e), based on calculated locations of the object relative to a field of view of a relevant imaging device (e.g., imaging device(s) 112). In some embodiments, motion measurement device 152 may be configured to generate a pulse count that can be used to identify the position of conveyor 116 along the direction of arrow 154. For example, motion measurement device 152 may provide the pulse count to image processing device 132 for identifying and tracking the positions of objects (e.g., objects 118d, 118e) on conveyor 116. In some embodiments, the motion measurement device 152 can increment a pulse count each time conveyor 116 moves a predetermined distance (encoder pulse count distance) in the direction of arrow 154. In some embodiments, an object's position can be determined based on an initial position, the change in the pulse count, and the pulse count distance.

In some embodiments, image processing device 132 (or a control device) can coordinate operations of various components of system 100. In some embodiments, image processing device 132 can control detailed operations of each imaging device, for example, by providing trigger signals to cause the imaging device to capture images at particular times, etc. Alternatively, in some embodiments, another device (e.g., a processor included in each imaging device, a separate controller device, etc.) can control detailed operations of each imaging device. For example, image processing device 132 (and/or any other suitable device) can provide a trigger signal to each imaging device, and a processor of each imaging device can be configured to implement a predesignated image acquisition sequence that spans a predetermined region of interest in response to the trigger. Note that system 100 can also include one or more light sources (not shown) to illuminate surfaces of an object, and operation of such light sources can also be coordinated by a central device (e.g., image processing device 132), and/or control can be decentralized (e.g., an imaging device can control operation of one or more light sources, a processor associated with one or more light sources can control operation of the light sources, etc.). For example, in some embodiments, system 100 can be configured to concurrently (e.g., at the same time or over a common time interval) acquire images of multiple sides of an object, including as part of a single trigger event. For example, each imaging device 112 can be configured to acquire a respective set of one or more images over a common time interval. Additionally or alternatively, in some embodiments, imaging devices 112 can be configured to acquire the images based on a single trigger event. For example, based on a sensor (e.g., a contact sensor, a presence sensor, an imaging device, etc.) determining that object 118 has passed into the FOV of the imaging devices 112, imaging devices 112 can concurrently acquire images of the respective sides of object 118. For example, a signal processing unit (e.g., signal processing unit 600) can include a light source control (e.g., light source control 618) configured to modulate the wavelength of a beam emitted by a light source (e.g., light source 512) with a nonlinear frequency sweep (e.g., in a sawtooth pattern or in a sinusoidal curve).

In some embodiments, each imaging device 112 can generate an image set depicting a FOV or various FOVs of a particular side or sides of an object supported by conveyor 116 (e.g., object 118). In some embodiments, image processing device 132 can map 3D locations of one or more corners of object 118 to a 2D location within each image in set of images output by each imaging device. In some embodiments, image processing device can generate a mask that identifies which portion of an image is associated with each side (e.g., a bit mask with a 1 indicating the presence of a particular side, and a 0 indicating an absence of a particular side) based on the 2D location of each corner. In some embodiments, the image processing device can stitch images associated with a same side of an object into one image that shows a more complete view of the side of the object (e.g., as described in U.S. application Ser. No. 17/019,742, filed on Sep. 14, 2020, which is hereby incorporated by reference herein in its entirety; and in U.S. application Ser. No. 17/837,998, filed on Jun. 10, 2022, which is hereby incorporated by reference herein in its entirety). In some embodiments, the 3D locations of one or more corners of a target object (e.g., object 118a) as well as the 3D locations of one or more corners of an object 118c (a leading object) ahead of the target object 118a on the conveyor 116 and/or the 3D locations of one or more corners of an object 118b (a trailing object) behind the target object 118a on the conveyor 116 may be mapped to a 2D location within each image in the set of images output by each imaging device. Accordingly, if an image captures more than one object (118a, 118b, 118c), one or more corners of each object in the image may be mapped to the 2D image.

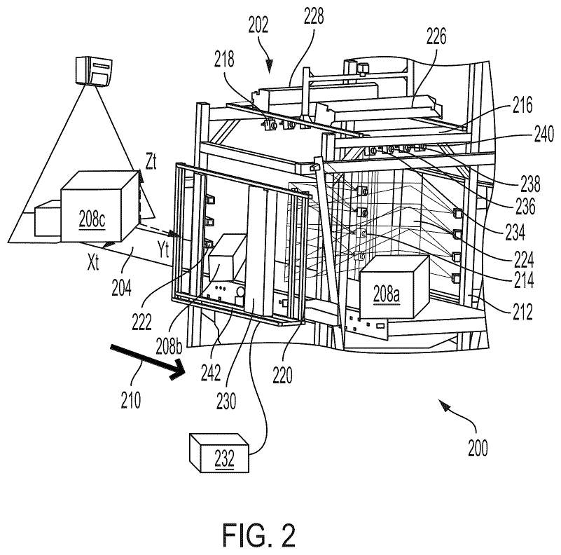

As mentioned above, one or more fixed and/or steerable mirrors can be used to redirect a FOV of one or more of the imaging devices, which may facilitate a reduced vertical or lateral distance between imaging devices and objects in tunnel 102. FIG. 2 shows another example of a system for capturing multiple images of each side of an object in accordance with an embodiment of the technology. System 200 includes multiple banks of imaging devices 212, 214, 216, 218, 220, 222 and multiple mirrors 224, 226, 228, 230 in a tunnel arrangement 202.

In some embodiments, system 200 also includes an image processing device 232. As discussed above, multiple objects 208a, 208b and 208c may be supported in the conveyor 204 and travel through the tunnel 202 along a direction indicated by arrow 210. In some embodiments, each bank of imaging devices 212, 214, 216, 218, 220, 222 (and each imaging device in a bank) can generate a set of images depicting a FOV or various FOVs of a particular side or sides of an object supported by conveyor 204 (e.g., object 208a).

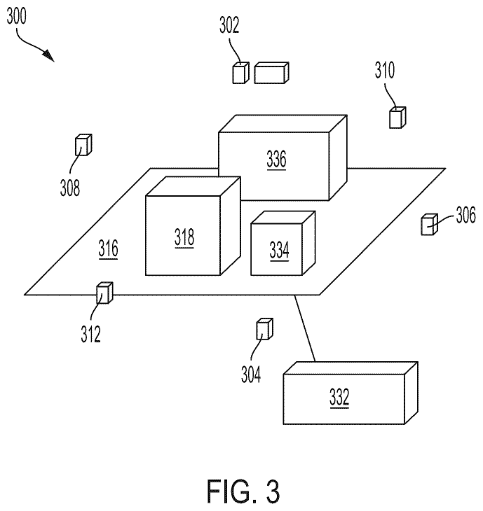

Note that although FIGS. 1A and 2 depict a dynamic support structure (e.g., conveyor 116, conveyor 204) that is moveable, in some embodiments, a stationary support structure may be used to support objects to be imaged by one or more imaging devices. FIG. 3 shows another example system for capturing multiple images of each side of an object in accordance with an embodiment of the technology. In some embodiments, system 300 can include multiple imaging devices 302, 304, 306, 308, 310, and 312, which can each include one or more image sensors, at least one lens arrangement, and at least one control device (e.g., a processor device) configured to execute computational operations relative to the image sensor.

In some embodiments, system 300 can be used to acquire images of multiple objects presented for image acquisition. For example, system 300 can include a support structure that supports each of the imaging devices 302, 304, 306, 308, 310, 312 and a platform 316 configured to support one or more objects 318, 334, 336 to be imaged (note that each object 318, 334, 336 may be associated with one or more symbols, such as a barcode, a QR code, etc.). For example, a transport system (not shown), including one or more robot arms (e.g., a robot bin picker), may be used to position multiple objects (e.g., in a bin or other container) on platform 316. In some embodiments, the support structure can be configured as a caged support structure. However, this is merely an example, and support structure can be implemented in various configurations.

In some embodiments, an image processing device 332 can coordinate operations of imaging devices 302, 304, 306, 308, 310, and/or 312 and/or may be configured similar to image processing device described herein (e.g., image processing device 132 of FIG. 1A, and image processing device 232 of FIG. 2).

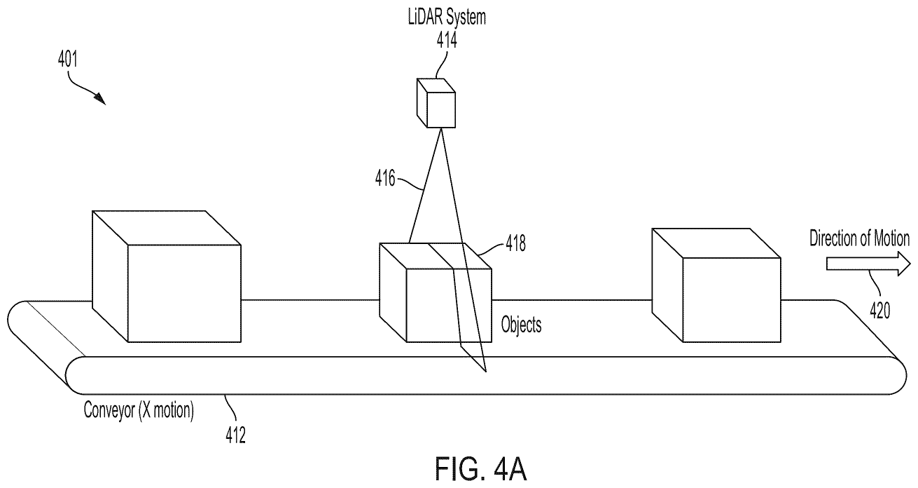

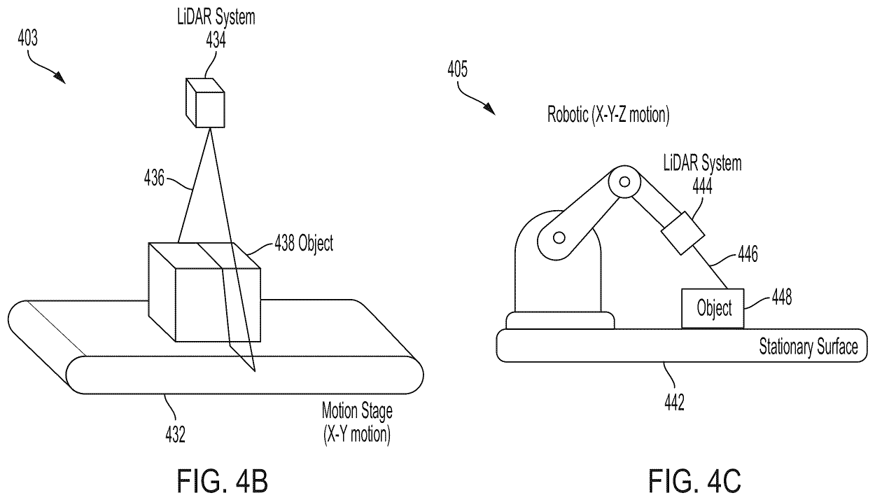

Machine vision systems described herein enable the use of FMCW LiDAR in systems (e.g., systems 100, 140, 200, and 300) to provide 3D images of objects, which can be processed to provide dimensions and/or shapes of the objects. FIGS. 4A-4C show schematic diagrams of exemplary machine vision systems 401, 403, and 405 configured to capture 3D images of objects. Each of the machine vision systems 401, 403, and 405 can be used in and/or with any of the systems 100, 140, 200, and 300.

A machine vision system may reduce the degrees of freedom required to sample a target object to produce a 3D image by detecting and using relative motions between the target object and an optoelectronic system configured to emit one or more beams to the target object. As illustrated, each of the machine vision systems 401, 403, and 405 can include a motion module (e.g., motion modules 412, 432, 442) configured to change the relative position and/or orientation between a target object (e.g., objects 428, 438, 448) and one or more components of an optoelectronic system (e.g., LiDAR systems 424, 434, 444) configured to emit beams (e.g., beams 426, 436, 446) to the target object.

In some embodiments, the motion module can be configured to move the target object. For example, as illustrated, the motion module 412 can be a conveyor configured to move the object 418 in a direction of motion 420, which may be referred to as the x direction. The motion module 412 can be configured to have one or more features of conveyors described herein (e.g., conveyors 116, 204). As another example, the motion module 431 can be a motion stage configured to move the object 438 in 2D directions on a plane such as an x-y plane, or in a 1D direction.

In some embodiments, the motion module can be configured to move one or more components of the optoelectronic system configured to emit beams to the target object. For example, as illustrated, the motion module 442 can be a robotic arm configured to move the one or more components of the LiDAR system 444 in 3D directions such as x, y and z directions.

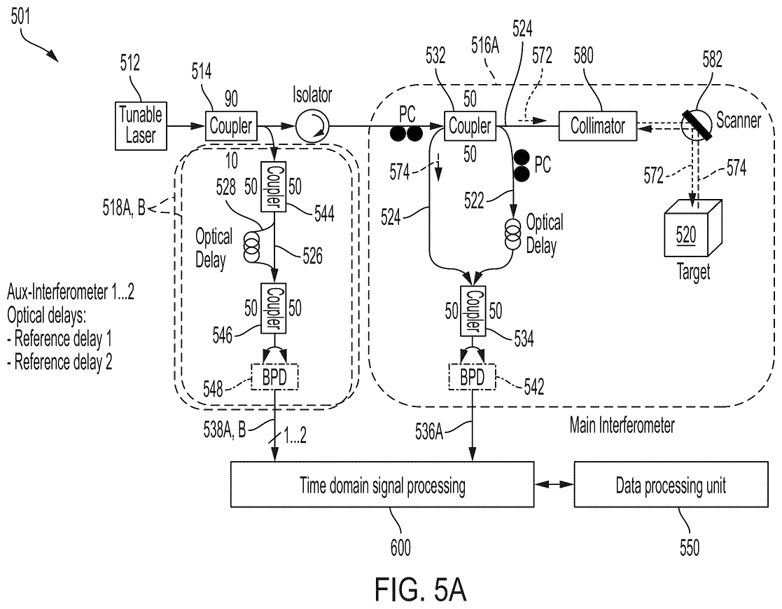

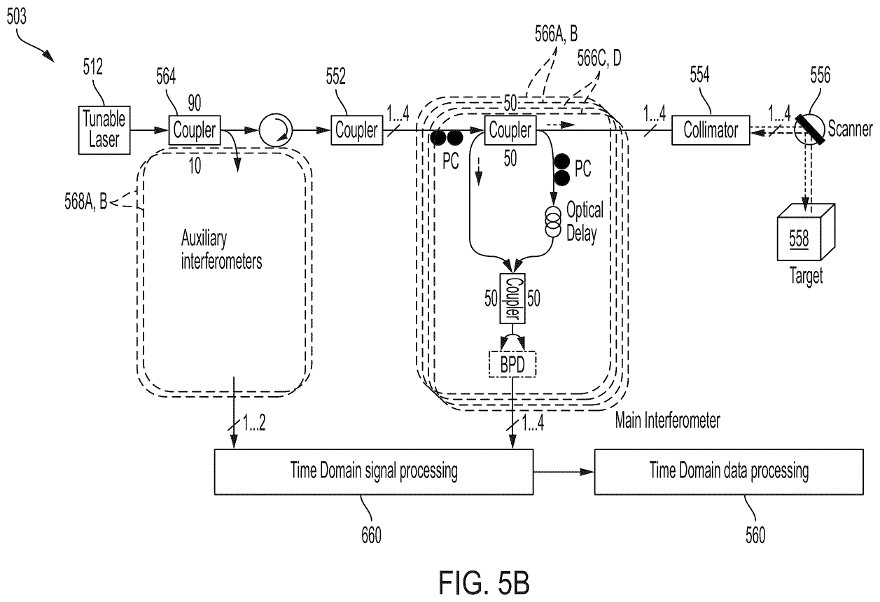

Such a configuration can enable the LiDAR system of the machine vision system to have one or more scanners configured to emit beams along 1D direction and/or 2D directions (e.g., scanner 522 of FIG. 5A, scanner 556 of FIG. 5B). Such a 1D and/or 2D scanner can eliminate the need for a more complex system and therefore reduce the computation requirements for the system to produce 3D images. For example, when a machine vision system has a motion module (e.g., a conveyor transporting parcels in a warehouse), an optoelectronic system can be configured to build on the existing motion module and emit beams along 1D direction. While a 2D scanner adds cost and complexity to a system, such a 1D scanner would operate faster than a 2D scanner and enable the motion module to move at a higher speed. As another example, when a machine vision system does not have a motion module or have a motion module that may not be sufficiently controlled (e.g., a human-operated fork truck in a warehouse), an optoelectronic system can be configured to emit beams along 2D directions, which can generate 3D images without a motion module (introducing a motion module for the purpose of forming 3D images is often complex, bulky, and costly). As illustrated, each of LiDAR systems 424, 434, 444 can include a 1D scanner configured to direct a beam towards the target object along 1D direction, and/or a 2D scanner configured to direct a beam towards the target object along 2D directions.

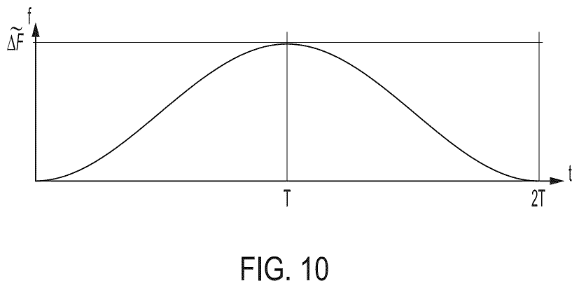

FIG. 5A shows a schematic diagram of an exemplary optoelectronic system 501, which can be used in a machine vision system such as systems 401, 403, 405 as at least part of respective LiDAR systems 424, 434, 444. As illustrated, the optoelectronic system 501 can include a light source 512 configured to emit a beam and modulate a wavelength of the beam. In other words, the light source 512 can be configured to sweep the frequency of the beam. For example, the light source 512 can be a tunable vertical-cavity surface-emitting laser (VCSEL). As another example, for logistics applications, it may be desirable to configure the light source 512 as a distributed feedback (DFB) laser. The light source 512 can be configured to sweep its frequency, for example, in a sawtooth pattern or in a sinusoidal curve (see, e.g., FIG. 10). The optoelectronic system 501 can include a signal processing unit (e.g., signal processing unit 600), which can include a light source control (e.g., light source control 618) configured to modulate the wavelength of a beam emitted by the light source 512 with a nonlinear frequency sweep (e.g., in a sawtooth pattern or in a sinusoidal curve).

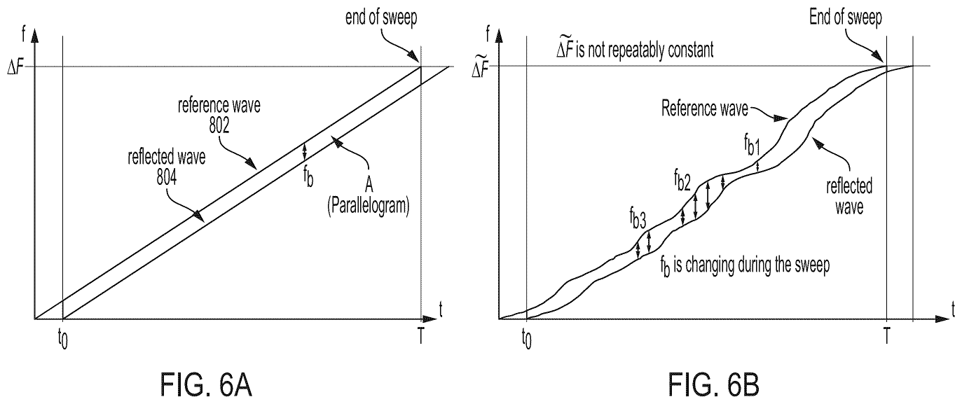

Conventional FMCW LiDAR systems typically require a precisely controlled linear frequency sweep characteristic such as the one shown in FIG. 6A. As shown in FIG. 6A, a beam with a long coherence length and a tunable wavelength is swept through a defined range by a constant frequency per time rate (ΔF/T), and sent into a reference arm of an interferometer as well as into a measurement arm that includes a path to an object and back. The reflected beam 804 interferes with the reference beam 802 in the reference arm after a total time (to) of flight back and forth to the object. The interference of the reference beam 802 and the measurement beam 804 forms a beat frequency (fb), which can be a direct measure of the distance R to the object when the slope of the frequency sweep rate (ΔF/T) is calibrated, constant, and repeatable. Conventionally, a photodetector converts the interference of the reference beam 802 and the measurement beam 804 into an electrical signal, which is digitized with a sample-and-hold device and an analog-to-digital converter. In the digital domain, a Fast Fourier Transform (FFT) is calculated and further processed. The beat frequency (fb) can thus be determined.

There can be various challenges to the conventional realization of FMCW LiDAR systems. First, as discussed above, conventional FMCW LiDAR systems require a precisely controlled linear frequency sweep characteristic. FIG. 6B is a graph showing a non-ideal frequency sweep. If the light source cannot be controlled with sufficient accuracy to act as a measurement reference, a range of beat frequencies (e.g., f_{b1}, f_{b2}, f_{b3}) would be generated, which cannot be identified and mapped to something meaningful. Depending on the nature of the frequency sweep, it can be a complex task to re-process the obtained data which has a big influence on the accuracy of the measurement and its robustness. Second, conventional FMCW LiDAR systems require high speed data acquisition with a powerful data processing unit, since the systems must operate at a sample rate at least twice the highest occurring signal frequency due to the Nyquist condition. This results in large amounts of data per time, which are subjected to complex numerical processing such as interpolation, resampling, and calculating FFTs.

Machine vision systems described herein can reduce the requirements for the accuracy of the sweep characteristics of the light source and/or the complexity of the data acquisition and data processing, without compromising the accuracy and/or resolution of the measurement results. Referring back to FIG. 5A, the optoelectronic system 501 can include one or more splitters (e.g., beamsplitter, or coupler 514) configured to split the beam provided by the light source 512 into multiple beams, a primary interferometer 516A configured to receive one of the split beams, first and second auxiliary interferometers 518A, 518B each configured to receive one of the split beams, signal processing unit 600 configured for processing outputs of the interferometers in the time domain, and data processing unit 550 configured for further processing outputs of the signal processing unit 600.

When the light source 512 feeding the primary interferometer 516A and first and second auxiliary interferometers 518A, 518B can shift the wavelength of the beam with respect to time, which may be described as sweeping the frequency of the beam, each interferometer described can produce a beat frequency corresponding to the frequency difference of the beams passing through two arms of the interferometer with different delays. The beat frequency in the primary interferometer 516A can be a function of the delay to a target object 520, whereas the beat frequencies in the first and second auxiliary interferometers 518A, 518B can reflect their fixed delays.

The coupler 514 can be configured to split the beam emitted by the light source into multiple beams, which can pass through respective interferometers. As illustrated, the coupler 514 can be a 90/10 coupler, which can split the beam into a first beam with 90% of the input optical power and a second beam with 10% of the input optical power. The first beam can be passed to the primary interferometer 516A. The second beam can be passed to the first and second auxiliary interferometers 518A, 518B. Although a 90/10 coupler is illustrated, it should be appreciated that the coupler 514 can have any suitable configuration such as 80/20, 70/30, etc. Although not illustrated, it should be appreciated that the beam emitted by the light source 512 can be split into second and third beams each passed to a respective one of the first and second auxiliary interferometers 518A, 518B.

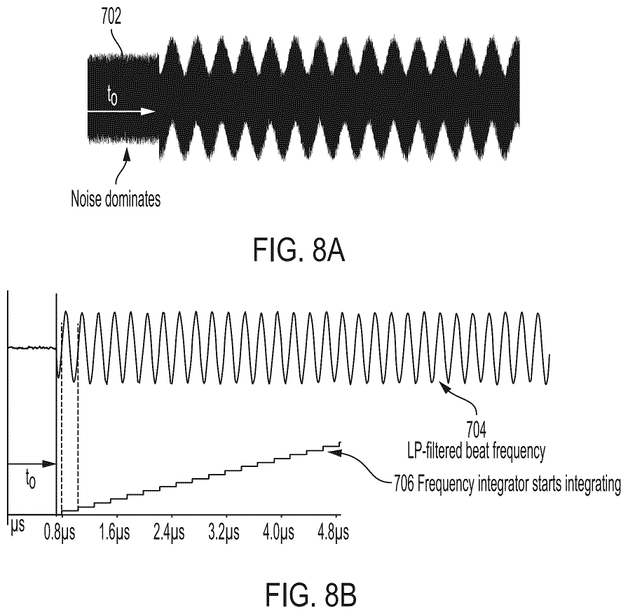

The primary interferometer 516A can have a reference arm 522, a measurement arm 524 that can include a path to the target object 520 and back, and a coupler 532 configured to split the first beam into a reference beam travelling along the reference arm 522 and a measurement beam 572 travelling along the measurement arm 524. The reference arm 522 may or may not have a known fixed delay. The measurement beam 572 can be reflected by the object 520 into a reflected measurement beam 574, which can travel back along the measurement arm 524. Another coupler 534 can be configured to combine the reference beam and the reflected measurement beam 574 into a combined beam, which is detected by a photodetector 542. The photodetector 542 can be configured to convert beat frequencies into electrical signals (e.g., electrical signal 702 of FIG. 8A). The photodetector 542 can output an electrical signal 536A, which can be provided to the signal processing unit 600. Although the photodetector 542 is illustrated as a balanced photodetector (BPD), it should be appreciated that the present disclosure is not intended to be limited in this aspect and other suitable photodetector can be used. As illustrated, the couplers 532, 534 can be 50/50 couplers, which are not intended to be limiting. Each frequency sweep of the beam can provide a measurement of one point of the object 520. The primary interferometer 516A can include a collimator 580 configured to narrow the measurement beam 572 into a parallel or nearly parallel stream and a scanner 582 configured to scan the measurement beam 572 along 1D direction and/or 2D directions, such that points of the object scanned by the measurement beam 572 can be measured. Examples of a scanner 582 include, but are not limited to, a galvanometer, voice coil, MEMS mirror, rotating polygon mirror, optical phased array, a waveguide switch bank, or other suitable technology. In some embodiments, when the scanner 582 is embodied in a waveguide switch bank, which can enable the removal of moving parts, the measurement beam 572 may first pass the scanner 582 and then the collimator 580.

The first and second auxiliary interferometers 518A, 518B can provide reference delays, to which the measured delay by the primary interferometer 516A may be compared. As illustrated, each of the first and second auxiliary interferometers 518A, 518B may have a first arm 526 and a second arm 528 that has a known fixed delay. The first auxiliary interferometer 518A may have a first known fixed delay, which may be referred to as a first reference delay. The second auxiliary interferometer 518B may have a second known fixed delay, which may be referred to as a second reference delay. The first and second reference delays may be predetermined based on, for example, ranges of target objects, such that delays caused by the target objects in the ranges measured by the primary interferometer 516A are between the first and second reference delays.

Each of the first and second auxiliary interferometers 518A, 518B can include a coupler 544 configured to split a respective beam (e.g., second beam or third beam) into a first beam travelling along the first arm 526 and a second beam travelling along the second arm 528. The second arm 528 can be configured to have the reference delay, such that a combined beam of the first beam and the second beam, combined by a coupler 546, can have a beat frequency that reflect a respective reference delay. The combined beam can be detected by a photodetector 548. The photodetector 548 can be configured to convert beat frequencies into electrical signals. The photodetector 548 can output a respective electrical signal 538A, 538B, which can be provided to the signal processing unit 600. As illustrated, the couplers 544, 548 can be 50/50 couplers, which are not intended to be limiting.

FIG. 5B shows a schematic diagram of a second exemplary optoelectronic system 503, which can be used in a machine vision system such as systems 401, 403, 405 as at least part of respective LiDAR systems 424, 434, 444. As illustrated, the second optoelectronic system 503 can have multiple primary interferometers 566A, 566B, 566C, 566D such that the number of spatially separated measurement points per sweep can be increased. The second optoelectronic system 503 can have optical components adapted to the multiple primary interferometers 566A, 566B, 566C, 566D such as a coupler 552, a collimator 554, and a scanner 556. The optical components can be configured to form beams for the multiple primary interferometers 566A, 566B, 566C, 566D, for example, in a fan-shape towards the target object 558. Each of the primary interferometers 566A, 566B, 566C, 566D may be configured similar to the primary interferometer 516A. The second optoelectronic system 503 can have a coupler 564 which can be configured similar to the coupler 514, first and second auxiliary interferometers 568A, 568B which can be configured similar to the first and second auxiliary interferometers 518A, 518B, a signal processing unit 660 which can be configured similar to the signal processing unit 600, and a data processing unit 560 which can be configured similar to the data processing unit 550. Although four primary interferometers 566A, 566B, 566C, 566D are illustrated in the second exemplary optoelectronic system 503, it should be appreciated that an optoelectronic system may have any suitable number of primary interferometers such as eight, sixteen, etc.

Optoelectronic systems (e.g., optoelectronic systems 501, 503) can be embodied in suitable systems, such as free space optical systems, fiber optic systems, or integrated optical systems. Implementing at least portions of the optoelectronic system as a photonic integrated circuit (PIC) can enable a more compact system that consumes less power while reducing manufacturing costs. In some embodiments, the auxiliary interferometers (e.g., 518A, 518B in FIG. 5A; 568A, 568B in FIG. 5B), the reference arms of the primary interferometer(s) (e.g., 516A in FIG. 5A; 566A, 566B, 566C, 566D in FIG. 5B), and at least portions of the measurement arm(s) of the primary interferometer(s) may be fabricated in one or more PICs. Such PICs may be referred to as interferometer PICs.

In some embodiments, a tunable laser (e.g., 512) may be integrated onto the same interferometer PIC as one or more of the interferometers. Alternatively or additionally, a separate chip or module may include the tunable laser, where the laser output is coupled to the interferometer PIC by, for example, butt coupling or fiber coupling.

In some embodiments, the photodetector(s) (e.g., 542, 548) may be integrated into the same interferometer PIC as one or more interferometers. Alternatively or additionally, a separate chip or module may include one or more photodetector(s).

In some embodiments, the scanner 582 may be integrated into the interferometer PIC using, for example, an optical phased array, a bank of optical switches, or other beam scanning technology. In some embodiments, the collimator 580 may not be a distinct component, with its function incorporated into another component. In some embodiments, when scanning via a bank of optical switches, different from the example shown in FIGS. 5A and 5B, the collimator may be disposed between the scanner and the object.

Although optoelectronic systems 501, 503 as illustrated in FIGS. 5A and 5 B include polarization controllers (PC), it should be appreciated that some embodiments may not include polarization control. Exemplary embodiments include free space systems, fiber optic systems constructed using polarization maintaining fiber, or integrated optical systems.

Although exemplary configurations of the interferometers (e.g., 516A, 518A, 518B, 566A, 566B, 566C, 566D, 568A, 568B) are described herein, it should be appreciated that an interferometer may have any other suitable configuration including, for example, a Mach-Zehnder, Michelson, etc.

Optoelectronic systems (e.g., optoelectronic systems 501, 503) may further comprises a processor configured to execute computer-executable instructions, the computer-executable instructions comprising a 3D imaging component, the 3D imaging component configured to: determine dimensions of an object measured by the first interferometer based, at least in part on, the delay of the first interferometer.

Machine vision systems described herein may measure the beat frequencies in the time domain, without FFTs. It is appreciated that the beat frequency can be determined based on an area A formed between a reference beam and a reflected beam in a graph of frequency versus time (e.g., FIG. 6A). A method for measuring the area A (FIG. 6A) can include measuring a frequency integral of an electrical signal (e.g., electrical signal 702 of FIG. 8A) provided by a photodetector (e.g., photodetectors 542, 548), which can work equally well for both constant sweep rate (e.g., as shown in FIG. 6A) and non-constant sweep rates (e.g., as shown in FIG. 6B). Assuming a time interval from t₁ until T whereas it can be t₀ until T, the area A can be expressed as

$$A = {\int }_{{t}_{1}}^{T} f ( t ) - f ( t - {t}_{0} ) d t \qquad Equation l$$

t₁ represents an arbitrary starting point for the integration.
With a Taylor series

$$f ( t - {t}_{0} ) = f ( t ) - \frac{{f}^{′} ( t ) \cdot {t}_{0}}{1 !} + \frac{{f}^{″} ( t ) \cdot {t}_{0}^{2}}{2 !} - \frac{{f}^{′′′} ( t ) \cdot {t}_{0}^{3}}{3 !}$$

the area A can be expressed as:

$$\begin{matrix}A = {\int }_{{t}_{1}}^{T} f ( t ) - [ f ( t ) - \frac{{f}^{′} ( t ) \cdot {t}_{0}}{1 !} + \frac{{f}^{″} ( t ) \cdot {t}_{0}^{2}}{2 !} - \frac{{f}^{′′′} ( t ) \cdot {t}_{0}^{3}}{3 !} …… ] dt \\ A = {\int }_{{t}_{1}}^{T} \frac{{f}^{′} ( t ) \cdot {t}_{0}}{1 !} \frac{{f}^{″} ( t ) \cdot {t}_{0}^{2}}{2 !} + \frac{{f}^{′′′} ( t ) \cdot {t}_{0}^{3}}{3 !} … dt \\ {⇒ A = {t}_{0} \cdot ( {\underbrace{f ( t )}}_{1 st} - {\underbrace{\frac{{f}^{′} ( t ) \cdot {t}_{0}}{2 !}}}_{2 nd} + {\underbrace{\frac{{f}^{″} ( t ) \cdot {t}_{0}^{2}}{3 !} ……}}_{higher} ) \vert}_{{t}_{1}}^{T}\end{matrix}$$

A separation of the first two elements of the frequency integral in Equation 2 gives:

$$\begin{matrix}{A}_{1 st} = {t}_{0} \cdot [ f ( T ) - f ( {t}_{1} ) ] = {t}_{0} \cdot Δ F \\ {A}_{2 n d} = \frac{{t}_{0}^{2}}{2} \cdot [ {f}^{′} ( T ) - {f}^{′} ( {t}_{1} ) ] = \frac{{t}_{0}^{2}}{2} \cdot ( {m}_{T} - {m}_{t 1} )\end{matrix}$$

Assuming that t₀ has a very small value, the higher order terms can be omitted, such that the frequency integral can be approximated by the first and the second element.

$$⇒ A \approx {A}_{1 st} - {A}_{2 n d} = {t}_{0} \cdot ( Δ F - {t}_{0} \cdot \frac{{m}_{T} - {m}_{t 1}}{2} ) \qquad Equation 3$$

ΔF represents frequency interval of the sweep; m_{T} represents the derivative of f(t) at t=T; and mₜ₁ represents the derivative of f(t) at t=t₁.
Referring to the frequency integral of an interferometer (e.g., a primary interferometer 516A) in Equation 3 as “A₀” and (m_{T}−mₜ₁)/2=m̅ then:

$$⇒ {A}_{0} = {t}_{0} \cdot ( Δ F - {t}_{0} \cdot \overline{m} ) \qquad Equation 4$$

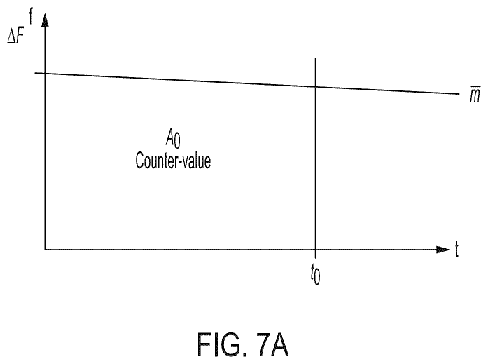

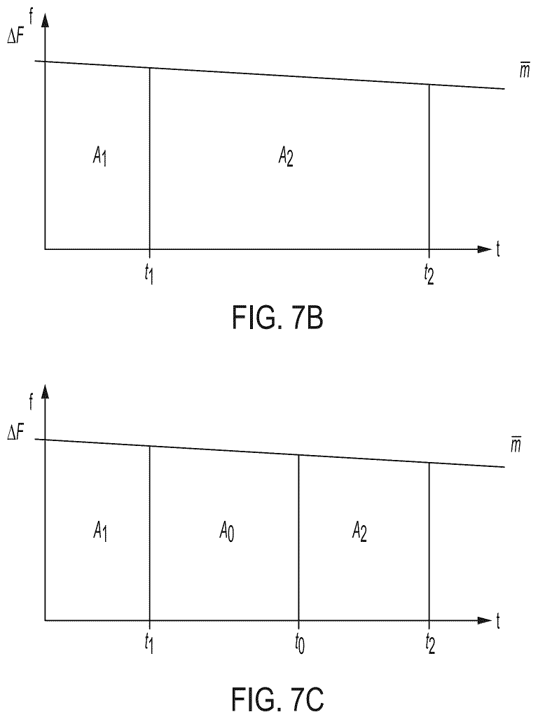

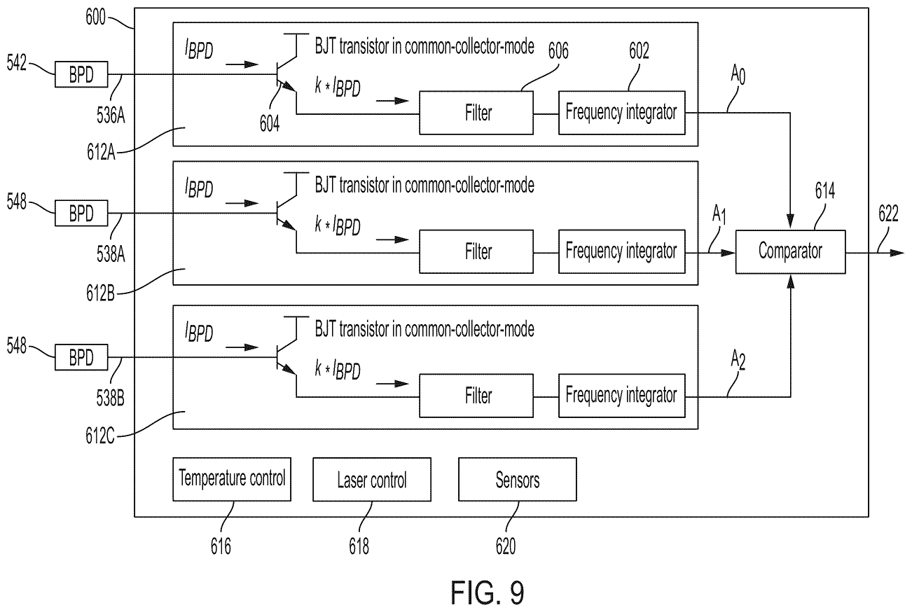

FIG. 7A shows a graphical representation of the frequency integral A₀ in Equation 4. The frequency integral A₀ can be obtained by a frequency integrator (e.g., frequency integrator 602 of FIG. 9), which can be realized by an averaging frequency counter with an adapted gating function and a multiplication by the gating interval (or leaving out the division by the gating time interval). Assuming the beam in an interferometer is switched on at the start of the sweep (t=0), FIG. 8A illustrated the beat frequency converted by a photodetector (e.g., photodetector 542) to an electrical current signal 702. As illustrated in FIG. 8B, the electrical current signal 702 can be isolated, for example, by low pass filtering, to provide a filtered electrical signal 704. The filtered electrical signal 704 can be fed to a frequency integrator to provide a frequency integral 706.

FIG. 9 shows a schematic diagram of an exemplary signal processing unit 600, which can be used in an optoelectronic system such as optoelectronic systems 501, 503. As illustrated, the signal processing unit 600 can include modules 612A, 612B, 612C. The module 612A can be configured to receive the electrical signal 536A provided by the photodetector 542 of the primary interferometer 516A and provide the frequency integral A₀. The module 612B can be configured to receive the electrical signal 538A provided by the photodetector 548 of the first auxiliary interferometer 518A and provide a frequency integral A₁. The module 612B can be configured to receive the electrical signal 538B provided by the photodetector 548 of the second auxiliary interferometer 518B and provide a frequency integral A₂.

Each of the modules 612A, 612B, 612C can include an amplifier (e.g., a current amplifier 604) configured to amplify the received electrical signal (e.g., electrical signals 536A, 536B, 536C, electrical signal 702 in FIG. 8A), a filter 606 configured to filter the amplified electrical signal to provide a filtered electrical signal (e.g., filtered electrical signal 704 in FIG. 8B), and the frequency integrator 602 configured to provide a frequency integral (e.g., frequency integral 706 in FIG. 8B, frequency integrals A₀, A₁, A₂).

The signal processing unit 600 can include a comparator 614 configured to compare the frequency integrals A₀, A₁, A₂ and provide a comparison result 622, which can indicate the delay to of the primary interferometer 516A that corresponds to the distance to the target object 520. Similar to FIG. 7A, FIG. 7B shows a graphical representation of the frequency integrals A₁ and A₂ of the first and second auxiliary interferometers 518A, 518B, with respect to their fixed reference delays t₁ and t₂ and the frequency sweep ΔF of the light source 512. The distance to the target object 520 corresponds to the delay to in the primary interferometer 516A. It is shown below that m̅ and ΔF can be computed from the frequency integrals A₁ and A₂ of the first and second auxiliary interferometers 518A,518B.

$$\begin{matrix}{A}_{1} = {t}_{1} \cdot Δ F - {t}_{1}^{2} \cdot \overline{m} \\ ⇒ Δ F = \frac{{A}_{1}}{{t}_{1}} + {t}_{1} \cdot \overline{m} \\ {A}_{2} = {t}_{2} \cdot Δ F - {t}_{2}^{2} \cdot \overline{m}\end{matrix}$$

FIG. 7C is a graphical representation of frequency integral A₀ of the primary interferometer 516A, with respect to the delay to, computed based on the frequency integrals A₁ and A₂ and the reference delays t₁ and t₂ of the first and second auxiliary interferometers 518A, 518B.

$$\begin{matrix}{A}_{0} = {t}_{0} \cdot Δ F - {t}_{0}^{2} \cdot \overline{m} \\ ⇒ {t}_{0} = \frac{Δ F}{\overline{2 m}} \pm \sqrt{{( \frac{Δ F}{\overline{2 m}} )}^{2} - \frac{{A}_{0}}{\overline{m}}}\end{matrix}$$

Such a method of measuring the distance to the target object can reduce the error by at least an order of magnitude for many realistic sweep functions.

It should be appreciated that the characteristics of the sweep are less significant for the optoelectronic systems described herein than conventional systems. Such a configuration enables optimizing a sweep to obtain the highest possible sweep rates provided by a given light source. For example, the light source 512 can be configured to provide a continuous sine wave as illustrated in FIG. 10, which can provide a technically advantageous sweep characteristic. Such a configuration can enable the use of inexpensive tunable VCSEL sources, whose wavelength tuning is accomplished via micromechanical devices (MEMS), to be operated free of harmonics at their resonant frequency. This enables the highest possible sweep rate with one up-sweep and one down-sweep per period. In some embodiments, the signal processing unit 600 can include a light source control 618 configured to control frequency sweep of the light source 512. the signal processing unit 600 can include other components such as a temperature control 616 and sensors 620. Although the signal processing unit 600 has the temperature control 616, light source control 618, and the sensors 620 in the illustrated example, it should be appreciated that one or more these components may be integrated with other components, or the signal processing unit 600 can have additional components, as the present disclosure is not intended to be limited in these regards.

Various aspects are described in this disclosure, which include, but are not limited to, the following aspects:

1. A system configured to generate a three-dimensional (3D) image of an object, the system comprising: a light source configured to emit a beam and modulate a wavelength of the beam; a coupler configured to split the beam into a first beam and a second beam; a first interferometer comprising a first reference arm and a first measurement arm, the first interferometer configured to: split the first beam into a first reference beam travelling along the first reference arm and a first measurement beam travelling along the first measurement arm, and provide a first output based on the first reference beam and a first reflected beam of the first measurement beam as reflected by the object; a second interferometer configured to provide a second output based on the second beam; a beam deflection device configured to direct the first measurement beam towards the object along a plurality of directions; and a motion module configured to provide a plurality of relative positions and/or orientations between the object and the beam deflection device, wherein the 3D image is generated, by a processor, based on the first output of the first interferometer, the second output of the second interferometer, the plurality of directions, and the plurality of relative positions and/or orientations.

2. A system configured to generate a three-dimensional (3D) image of an object, the system comprising: a light source configured to emit a beam and modulate a wavelength of the beam; a coupler configured to split the beam into a plurality of first beams and a second beam; a plurality of first interferometers, each of the plurality of first interferometers comprising a first reference arm and a first measurement arm and configured to: split a respective one of the plurality of first beams into a first reference beam travelling along the first reference arm and a first measurement beam travelling along the first measurement arm, and provide a first output based on the first reference beam and a first reflected beam of the first measurement beam as reflected by the object; a second interferometer configured to provide a second output based on the second beam; a beam deflection device configured to direct the first measurement beams towards the object along a plurality of directions; and a motion module configured to provide a plurality of relative positions and/or orientations between the object and the beam deflection device, wherein the 3D image is generated, by a processor, based on the first outputs of the plurality of first interferometers, the second output of the second interferometer, the plurality of directions, and the plurality of relative positions and/or orientations.

3. A system configured to generate a three-dimensional (3D) image of an object in relative motion to the system, the system comprising: a light source configured to emit a beam and modulate a wavelength of the beam; a coupler configured to split the beam into a first beam and a second beam; a first interferometer comprising a first reference arm and a first measurement arm, the first interferometer configured to: split the first beam into a first reference beam travelling along the first reference arm and a first measurement beam travelling along the first measurement arm, and provide a first output based on the first reference beam and a first reflected beam of the first measurement beam as reflected by the object; a second interferometer configured to provide a second output based on the second beam; and a beam deflection device configured to direct the first measurement beam towards the object along a plurality of directions, the relative motion of the object providing a plurality of positions between the object and the beam deflection device, wherein: the 3D image is generated, by a processor, based on the first output of the first interferometer, the second output of the second interferometer, the plurality of directions, and the plurality of positions.

4. The system of any one of aspects 1-3 or any other aspect, wherein the plurality of directions are along a same plane.

5. The system of any one of aspects 1-3 or any other aspect, wherein the light source is configured by a controller to modulate the wavelength of the beam by a nonlinear frequency sweep.

6. The system of aspect 5 or any other aspect, wherein the light source is configured to modulate the wavelength of the beam by a sinusoidal frequency sweep.

7. The system of any one of aspects 1-3 or any other aspect, wherein the second interferometer is configured with a reference delay; and the second output of the second interferometer corresponds to the reference delay.

8. The system of aspect 1 or any other aspect, comprising: a first frequency integrator configured to determine a first count of oscillations in the first output of the first interferometer; and a second frequency integrator configured to determine a second count of oscillations in the second output of the second interferometer, wherein the 3D image is generated based on the first count of oscillations and the second count of oscillations.

9. The system of any one of aspects 1-3 or any other aspect, comprising: a third interferometer configured to provide a third output based on the second beam, wherein the 3D image is generated based on the third output of the third interferometer.

10. The system of aspect 9 or any other aspect, wherein the third interferometer is configured with a second reference delay; and the third output of the third interferometer corresponds to the second reference delay.

11. The system of any one of aspects 1-3 or any other aspect, wherein the motion module is configured to support the object.

12. The system of aspect 11 or any other aspect, wherein the motion module is configured to move the object in 1D direction or 2D directions.

13. The system of any one of aspects 1-3 or any other aspect, wherein the motion module is configured to support the beam deflection device.

14. The system of aspect 13 or any other aspect, wherein the motion module is configured to move the beam deflection device in 3D directions.

15. A method for measuring distances to an object, the method comprising: modulating a wavelength of a beam that is split into a first beam emitted to a point of the object through a first interferometer, a second beam passing through a second interferometer, and a third beam passing through a third interferometer; converting outputs of the first interferometer, the second interferometer, and the third interferometer to a first electrical signal, a second electrical signal, and a third electrical signal, respectively; measuring a first frequency integral, a second frequency integral, and a third frequency integral based on the first electrical signal, the second electrical signal, and the third electrical signal, respectively; and determining the distance to the point of the object based on the first frequency integral, the second frequency integral, and the third frequency integral.

16. The method of aspect 15 or any other aspect, wherein the determined distance is a distance between the first interferometer and the point of the object.

17. The method of aspect 15 or any other aspect, wherein measuring the first frequency integral, the second frequency integral, and the third frequency integral comprises counting oscillations in the first electrical signal, the second electrical signal, and the third electrical signal, respectively.

18. The method of aspect 15 or any other aspect, wherein the wavelength of the beam is modulated by a sinusoidal frequency sweep.

19. The method of aspect 15 or any other aspect, wherein the point of the object is a first point of the object; and the method comprises: deflecting the beam along a plurality of directions such that the first beam is emitted to a plurality of points of the object including the first point of the object through the first interferometer; and determining the distances to the plurality of points of the object based on the first frequency integral, the second frequency integral, and the third frequency integral.

20. The method of aspect 19 or any other aspect, further comprising: determining dimensions of the object based on the determined distances to the plurality of points of the object.

21. The method of aspect 15 or any other aspect, comprising: splitting the first beam into a plurality of first beams; and emitting the plurality of first beams to a plurality of points of the object through a plurality of first interferometers, wherein the plurality of points include the point of the object, and the plurality of first interferometers comprise the first interferometer.

22. The method of aspect 21 or any other aspect, comprising: converting outputs of the plurality of first interferometers to a plurality of first electrical signals; measuring a plurality of first frequency integrals based on the plurality of first electrical signals; and determining distances to the plurality of points of the object based on the plurality of first frequency integrals, the second frequency integral, and the third frequency integral.

23. The method of aspect 22 or any other aspect, comprising: determining dimensions of the object based on the determined distances to the plurality of points of the object.

24. An optoelectronic system, comprising: a first receiver configured to receive a first output of a first interferometer; a first frequency integrator configured to provide a first frequency integral based on the first output of the first interferometer; a second receiver configured to receive a second output of a second interferometer; a second frequency integrator configured to provide a second frequency integral based on the second output of the second interferometer; a third receiver configured to receive a third output of a third interferometer; a third frequency integrator configured to provide a third frequency integral based on the third output of the third interferometer; and a comparator configured to compare the first frequency integral to the second frequency integral and the third frequency integral, wherein the comparison result indicates a delay of the first interferometer.

25. The optoelectronic system of aspect 24 or any other aspect, comprising: a current amplifier configured to amplify the first output of the first interferometer.

26. The optoelectronic system of aspect 25 or any other aspect, comprising: a filter configured to filter an amplified first output of the first interferometer.

27. The optoelectronic system of aspect 26 or any other aspect, wherein: the first frequency integrator is configured to count oscillations in a filtered, amplified first output of the first interferometer.

28. The optoelectronic system of aspect 24 or any other aspect, further comprising: a processor configured to execute computer-executable instructions, the computer-executable instructions comprising a 3D imaging component, the 3D imaging component configured to: determine dimensions of an object measured by the first interferometer based, at least in part on, the delay of the first interferometer.

Having thus described several aspects of several embodiments of a machine vision system and method of operating the machine vision system, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

Further, though some advantages of the present disclosure may be indicated, it should be appreciated that not every embodiment of the disclosure will include every described advantage. Some embodiments may not implement any features described as advantageous. Accordingly, the foregoing description and drawings are by way of example only.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be understood that the above-described acts of the methods described herein can be executed or performed in any order or sequence not limited to the order and sequence shown and described. Also, some of the above acts of the methods described herein can be executed or performed substantially simultaneously where appropriate or in parallel to reduce latency and processing times.

All definitions, as defined and used, should be understood to control over dictionary definitions, definitions in documents incorporated by reference, and/or ordinary meanings of the defined terms.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1-28. (canceled)

29. A system configured to generate a three-dimensional (3D) image of an object, the system comprising:
a light source configured to emit a beam and modulate a wavelength of the beam;
a coupler configured to split the beam into a first beam and a second beam;
a first interferometer comprising a first reference arm and a first measurement arm, the first interferometer configured to:
split the first beam into a first reference beam travelling along the first reference arm and a first measurement beam travelling along the first measurement arm, and
provide a first output based on the first reference beam and a first reflected beam of the first measurement beam as reflected by the object;
a second interferometer configured to provide a second output based on the second beam;
a beam deflection device configured to direct the first measurement beam towards the object along a plurality of directions; and
a motion module configured to provide a plurality of relative positions between the object and the beam deflection device, wherein:
the 3D image is generated, by a processor, based on the first output of the first interferometer, the second output of the second interferometer, the plurality of directions, and the plurality of relative positions and/or orientations.

30. The system of claim 29, wherein:
the plurality of directions are along a same plane.

31. The system of claim 29, wherein:
the light source is configured by a controller to modulate the wavelength of the beam by a nonlinear frequency sweep.

32. The system of claim 31, wherein:
the light source is configured by the controller to modulate the wavelength of the beam by a sinusoidal frequency sweep.

33. The system of claim 29, wherein:
the second interferometer is configured with a reference delay; and
the second output of the second interferometer corresponds to the reference delay.

34. The system of claim 29, comprising:
a first frequency integrator configured to determine a first count of oscillations in the first output of the first interferometer; and
a second frequency integrator configured to determine a second count of oscillations in the second output of the second interferometer, wherein:
the 3D image is generated based on the first count of oscillations and the second count of oscillations.

35. The system of claim 29, comprising:
a third interferometer configured to provide a third output based on the second beam, wherein:
the 3D image is generated based on the third output of the third interferometer.

36. The system of claim 35, wherein:
the third interferometer is configured with a second reference delay; and
the third output of the third interferometer corresponds to the second reference delay.

37. The system of claim 29, wherein:
the motion module is configured to support the object.

38. The system of claim 37, wherein:
the motion module is configured to move the object in a one-dimensional (1D) direction or two-dimensional (2D) directions.

39. The system of claim 29, wherein:
the motion module is configured to support the beam deflection device.

40. The system of claim 39, wherein:
the motion module is configured to move the beam deflection device in 3D directions.

41. A system configured to generate a three-dimensional (3D) image of an object in relative motion to the system, the system comprising:
a light source configured to emit a beam and modulate a wavelength of the beam;
a coupler configured to split the beam into a first beam and a second beam;
a first interferometer comprising a first reference arm and a first measurement arm, the first interferometer configured to:
split the first beam into a first reference beam travelling along the first reference arm and a first measurement beam travelling along the first measurement arm, and
provide a first output based on the first reference beam and a first reflected beam of the first measurement beam as reflected by the object;
a second interferometer configured to provide a second output based on the second beam; and
a beam deflection device configured to direct the first measurement beam towards the object along a plurality of directions, the relative motion of the object providing a plurality of positions between the object and the beam deflection device, wherein:
the 3D image is generated, by a processor, based on the first output of the first interferometer, the second output of the second interferometer, the plurality of directions, and the plurality of positions.

42. The system of claim 41, wherein:
the plurality of directions are along a same plane.

43. The system of claim 41, wherein:
the light source is configured by a controller to modulate the wavelength of the beam by a nonlinear frequency sweep.

44. The system of claim 43, wherein:
the light source is configured by the controller to modulate the wavelength of the beam by a sinusoidal frequency sweep.

45. The system of claim 41, wherein:
the second interferometer is configured with a reference delay; and
the second output of the second interferometer corresponds to the reference delay.

46. The system of claim 41, comprising:
a third interferometer configured to provide a third output based on the second beam, wherein:
the 3D image is generated based on the third output of the third interferometer;
the third interferometer is configured with a second reference delay; and
the third output of the third interferometer corresponds to the second reference delay.

47. A system configured to generate a three-dimensional (3D) image of an object, the system comprising:
a light source configured to emit a beam and modulate a wavelength of the beam;
a coupler configured to split the beam into a plurality of first beams and a second beam; a plurality of first interferometers, each of the plurality of first interferometers comprising a first reference arm and a first measurement arm and configured to:
split a respective one of the plurality of first beams into a first reference beam travelling along the first reference arm and a first measurement beam travelling along the first measurement arm, and
provide a first output based on the first reference beam and a first reflected beam of the first measurement beam as reflected by the object;
a second interferometer configured to provide a second output based on the second beam;
a beam deflection device configured to direct the first measurement beams towards the object along a plurality of directions; and
a motion module configured to provide a plurality of relative positions and/or orientations between the object and the beam deflection device, wherein:
the 3D image is generated, by a processor based on the first outputs of the plurality of first interferometers, the second output of the second interferometer, the plurality of directions, and the plurality of relative positions and/or orientations.

48. The system of claim 47, wherein:
the second interferometer is configured with a reference delay; and
the second output of the second interferometer corresponds to the reference delay.
